(19) United States
(12) Patent Application Publication
(10) Pub. No.: US 2026/0063194 A1
(43) Pub. Date: Mar. 5, 2026

(54) GEARBOX ARRANGEMENT AND MOTOR VEHICLE WITH A TRANSMISSION ARRANGEMENT

(71) Applicant: Dziuba Gears GmbH, Trossingen (DE)

(72) Inventors: Christoph Reinhard, Augsburg (DE); Josef Bauer, Nandlstadt (DE); Robert Honzek, Oberthingau (DE)

(21) Appl. No.: 19/310,736

(22) Filed: Aug. 26, 2025

(30) Foreign Application Priority Data
Aug. 27, 2024 (DE) 10 2024 124 430.5

(51) Int. Cl. F16H 47/04; B60K 17/28; B62D 11/12; F16H 47/02; F16H 63/30

(52) U.S. Cl. CPC F16H 47/04; B60K 17/28; F16H 63/302; B62D 11/12; F16H 2047/025; F16H 2047/045

(57) ABSTRACT

The disclosure relates to double provided power split transmission with a drive shaft, with a first branch comprising a planetary gear arrangement with two sun gears, a first ring gear and a planetary web, on which double planetary gears are arranged, which mesh with the sun gears and with the first ring gear, one of the sun gears being coupled to the drive shaft, with an adjustable second branch, which can be partially connected to the first branch via the planetary gear arrangement and has at least two hydraulic units which can be energetically coupled to one another and can be operated in each case in both directions as a motor or pump, and with an output shaft which can be coupled to the drive shaft via the first branch and the second branch, the planetary gear arrangement being provided with a planetary reversing gear is assigned.

### BACKGROUND

### Technical Field

The present disclosure relates to a transmission arrangement for a motor vehicle comprising a power split transmission. The present disclosure also relates to a motor vehicle with a corresponding transmission arrangement.

### Description of the Related Art

When internal combustion engines are used in motor vehicles, it is necessary to couple them with gearboxes in order to be able to operate the internal combustion engines at their favorable operating points over a wide speed range. Examples of this are tractors for agricultural use, where the speed in the field may only reach 0.4 km/h in some cases for manual planting, while speeds of 60 km/h or higher are desired for transfer between the field and the farm. For gearboxes with a given number of gears continuous operation of the engine in its optimum range is not guaranteed, so that the need arose very early on to achieve a continuous change in the transmission ratio in order to be able to offer a vehicle speed independent of the engine speed.

WO2006/042434A1 discloses a power split gearbox suitable for use in agricultural vehicles, wherein a stepped planetary gearbox is arranged between the input shaft coupled to the internal combustion engine and an output shaft to provide the power split of the power provided at the input shaft to the mechanical power branch and the hydraulic power branch.

The hydraulic power branch is formed by two hydraulically connected axial piston machines of the same type. The hydraulic power branch is formed by two hydraulically interconnected, identical hydrostatic axial piston machines, which can be used either as a pump or motor and can be swiveled in a predetermined swivel angle range. The two hydrostatic axial piston machines as hydraulic units can be connected to cover different travel ranges or travel stages via two clutches. The two hydraulic units are designed as wide-angle hydrostats.

This publication can be used as a reference for knowledge of the person skilled in the art, as this publication explains in detail how the power split transmission and the wide-angle hydrostats used in it work.

The disadvantages of this power split transmission are however, that the reverse travel has a poor efficiency. In WO2016/102572A1, a reversing stage is therefore provided between the input shaft and the output shaft for changing between a forward travel range and a reverse travel range, whereby the reversing stage either reverses all directions of rotations or keep all constant of the sun wheels of the ring gear and the planetary gear arrangement when changing between the forward travel range and the reverse travel range. When changing between the forward travel range and the reverse travel range, the relative directions of rotation of the sun gears, the ring gear and the web shaft are therefore kept synchronized so that not individual components of the planetary gearbox arrangement are reversed while other components are not reversed, so that is impossible for the direction of rotation to overlap when changing between the forward and reverse travel ranges in the planetary gearbox arrangement.

The reversing stage comprises two clutch elements between one output side of the planetary gear arrangement and the output shaft, whereby torque is transmitted via the first clutch element in the forward travel range and torque is transmitted via the second clutch element in the reverse travel range.

EP4151885A1 discloses a power split transmission of the same applicant as in the present disclosure. This publication contains a detailed explanation of the structure and mode of operation of the power split transmission, which can support the present disclosure. This power split transmission is formed with a drive shaft, with a first, mechanical branch comprising a planetary gear arrangement with at least two sun gears, a first ring gear and a planetary web, on which double planetary gears are arranged, which meshes with the sun wheels and with the first ring gear, at least one of the sun wheels being coupled to the drive shaft, with an infinitely variable second branch which is at least partially connectable to the first, mechanical branch via the planetary gear arrangement and comprises at least two adjustable hydraulic units which can be energetically coupled to one another and can be operated in both directions as a motor or pump, and with an output shaft which can be coupled to the drive shaft via the first, mechanical branch and the second branch, the planetary gear arrangement being assigned a planetary reversing gear by way of which the direction of rotation of the first, mechanical branch can be reversed. This power split transmission has very advantageous properties, in particular because the direction of rotation of the components of the planetary gearbox arrangement is maintained for both the forward travel range and the reverse travel range, and the planetary reversing gear is used to reverse the direction of rotation of the planetary gear arrangement when changing the direction of travel, so that the output shaft is driven in the correct direction of rotation. It is not necessary to use clutches, which reduces complexity and saves installation space. The reverse travel range is equivalent to the forward travel range without reactive power being generated. From a summing shaft, to which the power of the first branch and the second branch is combined, the power can be distributed to the front axle and the rear axle via a differential.

The transmissions known from the state of the art are usually very complex. In some cases, gearboxes particularly for use in tracked vehicles require superimposed steering gears. Furthermore, the maximum speed that can be achieved with known gearboxes for tracked vehicles, approx. 60 km/h.

DE102007013493A1 discloses a drive unit for infinitely variable speed control, which comprises two identical gear modules with means for power splitting, infinitely variable speed control and reversal of direction of rotation as well as a common drive.

DE7007244U discloses a steering gear that uses three bevel gears.

DE112004000874B4 and DE1555612A disclose transmission arrangements with two continuously variable transmissions which together transmit the entire drive power.

### BRIEF SUMMARY

Therefore, the present disclosure provides a transmission arrangement for a motor vehicle, in particular a tracked vehicle, whose design is simplified and with which higher speeds can be achieved.

Some embodiments relate to a transmission arrangement for a motor vehicle comprising a power split transmission, wherein the power split transmission is equipped with:
a drive shaft,
a first, mechanical branch comprising a planetary gear arrangement with at least a first sun gear and a second sun gear, a first ring gear and a planetary web, on which double planet gears are arranged, which mesh with the sun gears and with the first ring gear, at least one of the sun gears being coupled to the drive shaft,
an infinitely variable second branch, which is at least partially connected to the first, mechanical branch via the planetary gear arrangement, mechanical branch and comprises at least two adjustable hydraulic units which can be energetically coupled to one another and can be operated in each case in both directions as a motor or pump, the first hydraulic unit being connected to the ring gear via a hydraulic unit gearwheel and an outer ring gear on an outer ring of the ring gear,
a summing shaft through which the force of the first, mechanical branch and of the second branch can be coupled, the planetary gear arrangement being assigned a planetary reversing gear by way of which the direction of rotation of the first, mechanical branch can be changed, wherein the power split transmission is provided in duplicate as a first power split transmission and as a second power split transmission, each power split transmission can be controlled separately, and the force can be transmitted from the summing shaft to a drive wheel assigned to the respective power splitting gear by each of the power splitting gears.

The aforementioned transmission arrangement enables a simple and compact transmission arrangement to be provided with which higher speeds can be achieved, for example up to 100 km/h. Due to the simple design and the use of the planetary reversing gearbox, the same components can be used for both power split transmission, so that the gearbox arrangement can be manufactured relatively cheaply, especially since a differential assigned to each power split gearbox can be dispensed with, thereby also reducing complexity.

The drive shafts of the first and second power split transmission are connected via a bevel gear set with three bevel gears, one of the bevel gears being connected via a motor drive shaft is connected to an engine. This means that both power split transmissions are driven by one engine, particularly an internal combustion engine. The connection via the bevel gear set with three bevel gears is a particularly simple and compact solution.

In some embodiments, the first power split transmission and the second power split transmission are each assigned to a chain drive. However, it is also possible to drive any type of motor vehicle. It is envisaged that a first chain can be driven by the first power splitter transmission and that a second chain can be driven by the second power splitter transmission. Thus several tracks can be driven separately by the respective power split transmission. For example, the first power split transmission can drive a left-hand chain of a tracked vehicle, and the second power split transmission can drive a right-hand chain of a tracked vehicle.

The use of a bevel gear set with three bevel gears, one of which is assigned to the motor drive shaft and one to each of the drive shafts of the power splitter gearboxes, means that the drive shafts of the power split transmissions have a different direction of rotation. From the point of view of the two power split transmissions, however, the direction of rotation is the same, so that identical parts can be used for the two power split transmissions.

It is therefore intended that the direction of rotation of the first power split transmission can be switched in the opposite direction to the direction of rotation of the second power split transmission. This means that the direction of rotation of the drive shafts of the power split transmissions can be reversed simply by shifting one of the power split transmissions to achieve the correct direction of rotation for the chains for forward or reverse travel.

In some embodiments of the present disclosure, the first and second power split transmission are provided with a reversible direction of rotation by shifting the planetary reversing gearboxes, each planetary reversing gearbox having an axially adjustable shift sleeve which, in a first axial position, transmits the direction of rotation of the planetary web directly to a reversing planet which in the first mechanical branch is non-positively connected to the summing shaft, and which in a second axial position is directly or indirectly blocked against rotation with respect to a gear housing of the respective power split transmission, so that the direction of rotation of the planetary web is reversed in this axial position and acts with a reversed direction of rotation on the summing shaft, via which the force of the first mechanical branch and the second hydrostatic branch is combined. This results in a particularly simple reversal of the direction of rotation, as the use of the planetary reversing gear means that additional clutches are not required, so that additional installation space is saved and the complexity of the transmission is reduced. The result is a simple and compact power split transmission in which the reverse travel range is driven in the same way as the forward travel range without the need for reactive power. The drive, in particular the chain drive takes place via the reversing planet, so that, compared to the state of the art, further gearwheels, which are assigned to the summing shaft and arranged downstream, can be dispensed with.

In some embodiments, in an operating mode corresponding to a forward travel, the shift sleeve of the first power split gearbox is in the first axial position and the shift sleeve of the second power split gearbox is in the second axial position. This makes it particularly easy to reverse the direction of rotation in terms of control by changing the axial position of the switching sleeve.

It is also envisaged that the drive shafts of the first and second power split transmission extend to the second sun gear of the planetary gearbox arrangement. This enables a simple structure, since the drive shaft does not extend through the planetary reversing gear, which means that no hollow shafts need to be used on which the planetary reversing gear has to be mounted.

In some embodiments of the present disclosure, the summing shaft due to a wheel set wheel set can be coupled to the second branch via a coupling shaft fitted with a clutch. This allows the force from the first mechanical branch and the second hydrostatic branch to be easily combined. In some embodiments, the wheel set comprises 3 spur gears, as this enables a particularly simple structure to be realized.

In some embodiments, the shifting sleeve is formed as a reversible hollow gear with a reversible planet with an assigned odd number of gears. This provides a particularly simple and compact solution for reversing the direction of rotation.

One aspect of the present disclosure provides for a second clutch to be assigned to the second branch. This allows the second branch to be controlled more flexibly.

Furthermore, it is provided that the second clutch is assigned to a hydrostatic shaft of the second hydraulic unit and is designed as a double claw clutch for interaction of the second hydraulic unit via a first gear transmission with the small sun gear in the first hydrostatic unit and to interact with the small sun gear in the second closed position via a second gear transmission. This means that the second branch can be used in a forward travel range and in a reverse travel range in a simple manner.

In some embodiments, auxiliary units can be driven via the motor drive shaft. This enables a simple design of the auxiliary drive, as it does not have to be taken from the drive shafts or the summing shaft.

In some embodiments, the planetary reversing gear has a sun gear that is directly and non-rotatably connected to the summing shaft. This enables a simple and compact design, as the force can be transmitted directly to the drive at the summing shaft.

The above-mentioned advantages and effects also apply mutatis mutandis to a motor vehicle with such a transmission arrangement.

The features and combinations of features mentioned above in the description as well as the features and combinations of features mentioned below in the figure description and/or shown alone in the figure are not only usable in the combination indicated in each case, but also in other combinations or on their own without leaving the scope of the present disclosure. Thus, embodiments which are not explicitly shown or explained in the figure, but which emerge from the explained embodiments and can be produced by separate combinations of features, are also to be regarded as being comprised and disclosed by the present disclosure.

### BRIEF DESCRIPTION OF THE SEVERAL VIEWS OF THE DRAWINGS

FIG. 1 is a schematic representation of a transmission arrangement according to an exemplary embodiment of the present disclosure.

FIG. 2 shows a speed-dependent representation of the hydrostatic power component (dashed line) and the efficiency of an exemplary embodiment of the present disclosure.

### DETAILED DESCRIPTION

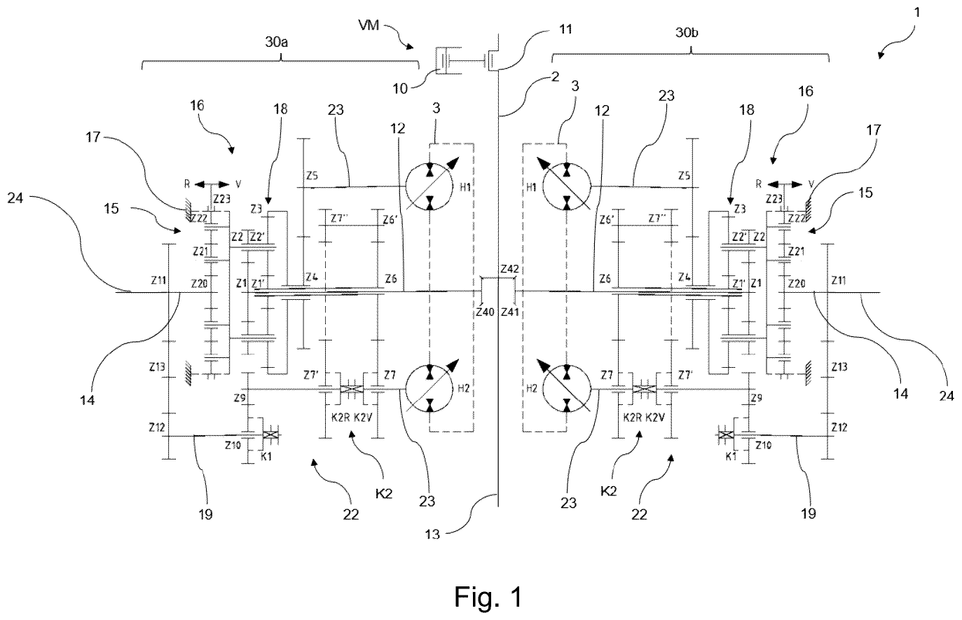

FIG. 1 shows a schematic representation of a transmission arrangement with a first power split transmission 30a and a second power split transmission 30b. The first and second power split transmissions 30a, 30b are essentially identical so that the function is explained below using the second power split gearbox 30b.

The power split transmission 30b is coupled by its drive shaft 12 to an internal combustion engine VM, which symbolized by a piston 10 connected to a crankshaft 11.

The drive shaft 12 can also be connected to the combustion engine VM via a torsion damper (not shown in the drawing) and a cardan shaft (not shown).

The drive shaft 12 of the second power split transmission 30b is connected to the internal combustion engine VM via a bevel gear set with a first bevel gear Z40, a second bevel gear Z41 and a third bevel gear Z42, with the third bevel gear Z42 being connected to an engine drive shaft 2. The first bevel gear Z40 is connected to the first power splitting transmission 30a and the second bevel gear Z41 is connected to the second power splitting transmission 30b. Due to the joint drive by way of the third bevel gear ZA2, the first bevel gear Z40 and the second bevel gear Z41 rotate in opposite directions, while the direction of rotation is the same when viewed from the gearbox input.

The engine drive shaft 2 is connected to a power take-off shaft 13 extending through the bevel gear set Z40, Z41, Z42, with which further components can be driven. For example, if the second power split transmission 30b is used in a tractor for the agricultural vehicle, a pump for the working hydraulics and a further pump for the steering can be driven via the power take-off shaft 13; it is also possible to drive other units. Additional units can also be driven in this way on construction site vehicles with a chain drive.

The second power split transmission 30b has a planetary gear arrangement 18 with a large first sun gear Z1 and a small second sun gear Z1′. The drive shaft 12 extents from the second bevel gear Z41 to the first sun gear Z1 of the planetary gear arrangement 18.

Furthermore, there are double planetary gears Z2 and Z2′, a first ring gear Z3 and a planetary bridge P. A first mechanical branch 16 runs via this planetary gear arrangement 18, through which the internal combustion engine VM power provides power via the motor drive shaft 2, the bevel gear set Z40, Z41, Z42 and the drive shaft 12 is fed to a summing shaft 14 and from this to a chain drive 24.

As a special feature of the first and second power split transmission 30a, 30b, a planetary reversing gear 15 is provided on the output side of the planetary gearbox arrangement 18 for easy changeover between a forward travel range V and a reverse travel range R. This planetary reversing gear 15, the direction of rotation of the first mechanical branch 16 can be reversed.

The planetary reversing gear 15 comprises an axially adjustable shift sleeve Z23 formed as a reversing hollow gear, which in a first axial position transmits the direction of rotation of the planetary web P directly to a reversing planet Z22, Z21, Z20, which is connected directly to the summing shaft 14 in the first mechanical branch 16 by way of the first reversing planet Z20.

In a second axial position, the shift sleeve Z23 is directly or indirectly blocked against rotation with respect to a gear housing 17 of the second power split transmission 30b, so that the direction of rotation of the planetary web P is reversed in this axial position and acts on the summing shaft 14 with a reversed direction of rotation. For this purpose the switching sleeve Z23 has a reversing planet Z20, Z21, Z22 with an assigned odd number of gears.

The second power split transmission 30b furthermore has a first hydraulic unit H1 and a second hydraulic unit H2, which provide a hydraulic, infinitely variable second branch 22 of the second power split transmission 30b. The two hydraulic units H1, H2 are hydraulically connected to each other via high-pressure channels 3.

The hydraulic units H1 and H2 are formed by wide-angle hydrostats of the bent-axis type, in which a cylinder block with the piston therein can be swiveled out of the axis of the associated hydrostatic shaft 23 to one side by a swivel angle. The basic structure and mode of operation of the wide-angle hydrostats is described in WO2006/042434A1 and is known therefrom.

If the hydrostatic shaft 23 and thus also the cylinder block are rotated around their respective axes via a synchronizing shaft at a constant swivel angle not equal to 0°, each of the pistons runs through a complete stroke cycle per revolution.

The first hydraulic unit H1 and/or the second hydraulic unit H2 can operate as a hydraulic pump if a drive is provided via the hydrostatic shaft 23 and a hydraulic medium is sucked in by the pistons moving out of the cylinder bore and pressed out by the piston moving in the cylinder bore. The larger the swivel angle, the greater the pump capacity in volume per revolution.

The first hydraulic unit H1 and/or the second hydraulic unit H2 can also operate as a hydraulic motor M if the cylinders are each supplied with a pressurized hydraulic medium and the rotational motion is taken from the hydrostatic shaft 23. The greater swivel angle, the greater the torque. The drive shaft 12 acts on the first hydraulic unit H1 via an outer ring gear ZA on the outer ring of the ring gear Z3 and via a hydro unit gear wheel Z5.

The second hydraulic unit H2 is coupled to the summing shaft 14 in the forward travel range V and in the reverse travel range R of stage 1 via a first clutch K1 and gear wheels Z9 and Z10 and via the spur gear set Z12, Z13, Z11.

In the embodiment shown in FIG. 1, the first clutch K1 is designed as a claw clutch assigned to the coupling shaft 19 for detachable interaction with a hydrostatic shaft 23 of the second hydraulic unit H2. Furthermore, the second coupling K2 is assigned to the hydrostatic shaft 23 of the second hydraulic unit H2 and designed as a double claw clutch K2V/K2R for the interaction of the second hydraulic unit H2 via a first gear transmission Z6, Z7 with the second sun gear Z1′ in the first closed position K2V, which is assigned to the forward travel range V and for interaction via a second gear transmission Z7′, Z7″, Z6′, Z6 with the first sun gear Z1′ in the second closed position K2R, which is assigned to the reverse travel range R.

In the embodiment shown in FIG. 1, the clutches K1, K2V und K2R are formed as claw clutches. The omission of K2R is possible in principle, but is associated with the loss of a second stage for the reverse travel range R.

The second hydraulic unit H2 can therefore be coupled to the summing shaft 14 via the first clutch K1 and, when the first clutch K1 is open, can be coupled to the planetary gear arrangement 18 with the second clutch K2 via the first gear reduction gear Z6, Z7 or the second gear reduction gear Z7′, Z7′, Z6′, Z6′ and the small sun gear Z1′.

The possible operating modes of the first and second power split transmission 30a, 30b with the structure described above are explained below. First, the mode of operation of the power split transmissions 30a, 30b is explained taking into account that the direction of rotation of the first bevel gear Z40 and the second bevel gear Z41 is different.

One possible operating mode is active standstill, in which the summing shaft 14 and the chain drive 24 are blocked and a type of “parking brake” is present. For this purpose, the second hydraulic unit H2 is fully swung out, while the first hydraulic unit H1 has a swivel angle of 0°. The first hydraulic unit H1 acts as a pump and the second hydraulic unit H2 as a motor so that the desired blockage is achieved via the second hydraulic unit H2 and the first clutch K1.

In the following, the forward travel range V is explained, in which one of the power split transmissions 30a, 30b has the shift sleeve Z23 in one axial position and the other power split transmission has the shift sleeve Z23 in the other axial position in order to match the direction of rotation of the summing shafts. Initially, when the motor vehicle with the power split transmissions 30a, 30b is stationary the second hydraulic unit H2 is fully swiveled out and the first hydraulic unit H1 has a swivel angle of 0°. The first hydraulic unit H1 acts as a pump and the second hydraulic unit H2 acts as a motor.

During start-up, the first hydraulic unit H1 swivels from 0° to a positive angle range, in the embodiment example shown counterclockwise, up to its maximum swivel angle, which is 45°, for example. The hydrostatic power from the first hydraulic unit H1 is fed to the second hydraulic unit H2, which operates as a motor, and is directed via the first clutch K1 to the summing shaft 14, which receives power mechanically via the mechanical branch 16 directly via the planetary web P and the reversing planets Z20, Z21, Z22.

As soon as the first hydraulic unit H1 reaches its maximum swivel angle, the second hydraulic unit H2 swivels back to a swivel angle of 0° and the first hydraulic unit H1 comes to a standstill.

The clutches K1 and K2 run synchronously and are unloaded, whereupon the first clutch K1 is opened, and the second clutch K2 is closed. As a result, the second hydraulic unit H2 is connected via the gear transmission Z6, Z7 to the small second sun gear Z1′ of the planetary gear arrangement 18.

By swiveling the second hydraulic unit H2 further in the opposite direction into a negative angle range, the direction of flow of the Hydraulic units H1 and H2 are switched so that a change is made to stage 2 of the forward travel range V, in which the second hydraulic unit H2 works as a pump and drives the first hydraulic unit H1. The hydrostatic and mechanical power are combined in the planetary gear arrangement 18 and the hydrostatically transmitted power increases. When the second hydraulic unit H2 is fully swung out, the first hydraulic unit H1 swings back to 0°, as a result of which the second hydraulic unit H2 is almost stationary and the power transmission is almost purely mechanical via the first, mechanical branch 16.

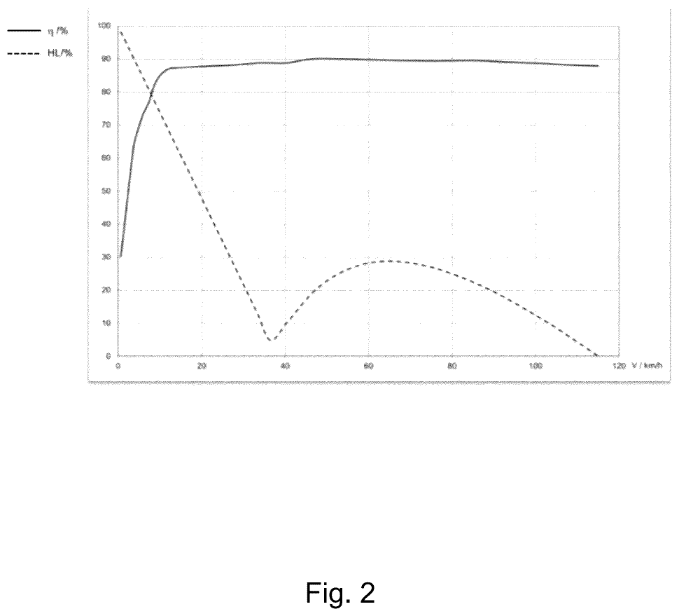

FIG. 2 shows the hydrostatic power component HL as a function of speed. It can be seen that when starting off, the hydrostatic power component HL is 100% and then drops almost linearly to 0%, whereby the switchover from the first stage to the second stage of the forward travel range V then takes place, whereupon the hydrostatic power component HL drops almost linearly to 0%. The power share HL increases again to approximately 29 percent and drops again after this maximum until finally the power transmission is purely mechanical.

FIG. 2 also shows the efficiency factor n, which is almost constant at a high level over the entire speed range.

The following explains the procedure when starting from a standstill in reverse travel range R. For the reverse travel range R the reversing ring gear as a shift sleeve Z23 is fixed in the axial position opposite of the axial position for the forward travel range relative to the transmission housing 17, so that the direction of rotation of the planetary bridge P is reversed. The second hydraulic unit H2 works as a motor and is fully swiveled out, while the first hydraulic unit H1 acts as a pump and swivels clockwise from the initial position 0° to −45°. The opposite swivel direction of the first hydraulic unit H1 into the negative angle range reverses the direction of rotation of the second hydraulic unit H2 and feeds it via the first clutch K1 with the corresponding direction of rotation to the summing shaft 14, which receives the mechanical power component via the planetary reversing gear 15 with the reversed direction of rotation.

The force flows are such that in the forward travel range V and in the Reverse travel range R the merging of the power components is basically the same.

In the following, the operating mode of the transmission arrangement 1 is explained specifically for the drive of a tracked vehicle. If the transmission arrangement 1 is used to drive a tracked vehicle, the first power split transmission 30a drives, for example, a first chain, which is designed, for example, as a left chain of a tracked vehicle. In this embodiment example, the second power split transmission 30b then drives a second chain, which is designed, for example, as a right-hand chain of a tracked vehicle.

Thus, the power splitting transmissions 30a, 30b, as shown in FIG. 1, is provided in duplicate, with each power splitting transmission 30a, 30b transmitting the power from the summing shaft 14 to a power splitting belonging to the respective power split transmission 30a, 30b to the drive wheel of a chain drive 24. The two hydraulic units H1, H2, the clutches K1, K2 and the adjustment of the shift sleeve Z23 for the first and second power split transmission 30a, 30b can be controlled separately.

As can be seen from FIG. 1, the first axial position of the shift sleeve Z23 of the first power split transmission 30a corresponds to the forward travel range V, while the first axial position of the shift sleeve Z23 of the second power split transmission 30b corresponds to the reverse driving travel R and the two hydraulic units are swiveled in the corresponding directions. These shift positions with opposite directions of rotation mean that both tracks move in the same direction.

If both power split transmissions 30a, 30b gears are set to V or R, a tracked vehicle can rotate on the spot.

These switching positions with opposite direction of rotation can be used to turn a tracked vehicle on the spot.

For forward or reverse travel, both power split transmissions 30a, 30b are then shifted into the forward travel range V or reverse travel range R via the shift sleeves Z23.

For cornering in the forward travel range V or reverse travel range R, the speed in one of the two power splitter transmission 30a, 30b is increased compared to the other. This can be achieved, for example, by swinging out a hydraulic unit H1, H2 more strongly. Due to the speed difference on the left and right side, cornering then occurs.

Such a transmission arrangement can therefore provide a particularly simple, compact and efficient drive for motor vehicles, especially tracked vehicles.

German patent application no. 102024124430.5, filed Aug. 27, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A transmission arrangement for a motor vehicle, comprising:
a first power split transmission and a second power split transmission, each of the first power split transmission and the second power split transmission including:
a drive shaft,
a first mechanical branch having a planetary gear arrangement with at least a first sun gear and a second sun gear, a ring gear, and a planetary web on which double planetary gears are arranged, the double planetary gears each configured to mesh with the first and second sun gears and with the first ring gear, at least one of the first and second sun gears is coupled to the drive shaft;
an infinitely variable second branch configured to be connected at least partially to the first mechanical branch via the planetary gear arrangement, the infinitely variable second branch comprising at least two adjustable hydraulic units, each adjustable hydraulic unit of the at least two adjustable hydraulic units configured to be energetically coupled to one another and act as a motor or a pump in both directions, wherein the first hydraulic unit is coupled to this ring gear via a hydraulic unit gear and an outer ring gear on an outer ring of the ring gear; and
a summing shaft configured such that a force of the first mechanical branch and a force the second branch can be coupled therethrough,
wherein a planetary reversing gear is associated with the planetary gear arrangement such that the direction of rotation of the first mechanical branch can reversed by way of the planetary reversing gear,
wherein each of the first power split transmission and the second split transmission are configured to be separately controllable,
wherein each of the first power split transmission and the second power split transmission are configured such that a force can be transmitted from the summing shaft to a drive wheel assigned to a respective power split transmission of the first power split transmission and the second power split transmission, and
wherein the drive shafts of the first and second power split transmissions are each connected to three bevel gears via a bevel gear set, one of the three bevel gears connected to a motor via a motor drive shaft.

2. The transmission arrangement according to claim 1, wherein the first power split transmission and the second power split transmission are each assigned to a chain drive.

3. The transmission arrangement according to claim 2, wherein a first chain is configured to be driven by the first power split transmission, and wherein a second chain is configured to be driven by the second power split transmission.

4. The transmission arrangement according to claim 1, wherein auxiliary units can be driven via the engine drive shaft.

5. The transmission arrangement according to claim 1, wherein the first power split transmission is configured such that the direction of rotation of the first power split transmission can be shifted in a direction opposite the direction of rotation of the second power split transmission.

6. The transmission arrangement according to claim 1, wherein first and second power split transmissions are configured such that the direction of rotation of the first and second power split transmissions can be reversed by shifting the planetary reversing gears, each planetary reversing gear having an axially adjustable shift sleeve configured, in a first axial position, to transmit the direction of rotation of the planetary web directly to a reversible planet, the reversible planet frictionally connected to the summing shaft in the first mechanical branch and, in a second axial position, to be directly or indirectly blocked against rotation with respect to a gear housing of the respective power split transmission, such that the direction of rotation of the planetary web is reversed in the second axial position and a reversed direction of rotation acts on the summing shaft, via which the force of the first mechanical branch and the second infinitely variable second branch are combined.

7. The transmission arrangement according to claim 6, wherein, in an operating mode corresponding to forward travel, the shift sleeve of the first power split transmission is in the first axial position and the shift sleeve of the second power split transmission is in the second axial position.

8. The transmission arrangement according to claim 6, wherein the shift sleeve is formed as a reversible hollow gear with a reversing planet with an associated odd number of gears.

9. The transmission arrangement according to claim 1, wherein the drive shafts of the first and second power split transmissions each extend to the first sun gear of the planetary gear arrangement.

10. The transmission arrangement according to claim 1, wherein the summing shaft is configured to be coupled by a wheel set to the second branch via a coupling shaft provided with a coupling.

11. The transmission arrangement according to claim 1, wherein a second clutch is assigned to the second branch.

12. The transmission arrangement according to claim 11, wherein the second clutch is assigned to a hydrostatic shaft of the second hydraulic unit of the at least two adjustable hydraulic units and is configured as a double claw clutch for the interaction of the second hydraulic unit via a first gear transmission with the small second sun gear in a first closed position and for interaction via a second gear transmission with the small second sun gear in a second closed position.

13. The transmission arrangement according to claim 1, wherein the planetary reversing gear includes a first reversible planet connected directly and non-positively to the summing shaft.

14. A motor vehicle comprising:
a transmission arrangement having:
a first power split transmission and a second power split transmission, each of the first power split transmission and the second power split transmission including:
a drive shaft,
a first mechanical branch having a planetary gear arrangement with at least a first sun gear and a second sun gear, a ring gear, and a planetary web on which double planetary gears are arranged, the double planetary gears each configured to mesh with the first and second sun gears and with the first ring gear, at least one of the first and second sun gears is coupled to the drive shaft;
an infinitely variable second branch configured to be connected at least partially to the first mechanical branch via the planetary gear arrangement, the infinitely variable second branch comprising at least two adjustable hydraulic units, each adjustable hydraulic unit of the at least two adjustable hydraulic units configured to be energetically coupled to one another and act as a motor or a pump in both directions, wherein the first hydraulic unit is coupled to this ring gear via a hydraulic unit gear and an outer ring gear on an outer ring of the ring gear; and
a summing shaft configured such that a force of the first mechanical branch and a force the second branch can be coupled therethrough,
wherein a planetary reversing gear is associated with the planetary gear arrangement such that the direction of rotation of the first mechanical branch can reversed by way of the planetary reversing gear,
wherein each of the first power split transmission and the second split transmission are configured to be separately controllable,
wherein each of the first power split transmission and the second power split transmission are configured such that a force can be transmitted from the summing shaft to a drive wheel assigned to a respective power split transmission of the first power split transmission and the second power split transmission, and
wherein the drive shafts of the first and second power split transmissions are each connected to three bevel gears via a bevel gear set, one of the three bevel gears connected to a motor via a motor drive shaft.
